(19) United States
(12) Patent Application Publication
(10) Pub. No.: US 2003/0223667 A1
(43) Pub. Date: Dec. 4, 2003

(54) Off-axis loaded bearing

(76) Inventor: Martin Nick Leibowitz, Hillsboro Beach, FL (US)

Correspondence Address: KIRKPATRICK & LOCKHART LLP, 75 STATE STREET, BOSTON, MA, 02109-1808, US

(21) Appl. No.: 10/157,577

(22) Filed: May 28, 2002

(51) Int. Cl. F16C 19/00; F16C 19/40; F16C 33/52

(52) U.S. Cl. 384/574; 384/553; 384/446

(57) ABSTRACT

A roller bearing having a central axis comprising an inner race having a first race track; an outer race disposed concentrically around the inner race with respect to the central axis and having a second race track facing the first race track; and a plurality of rolling bodies disposed between the inner race and the outer race for rolling against the first race track and the second race track. Each of the plurality of rolling bodies has a fixed axis of rotation about which each of the rolling bodies rotates, each of the rolling bodies being rotatably attached to the roller bearing such that the fixed axis of rotation about which each of the rolling bodies rotates remains substantially parallel to the central axis of the roller bearing.

### BACKGROUND

A roller bearing may be used in various applications to reduce the friction between a fixed and a moving surface. Bearings may also be designed to accommodate various loads.

### SUMMARY OF THE INVENTION

An embodiment of the present invention is directed to a roller bearing having a central axis comprising an inner race having a first race track; an outer race disposed concentrically around the inner race with respect to the central axis and having a second race track facing the first race track; and a plurality of rolling bodies disposed between the inner race and the outer race for rolling against the first race track and the second race track. Each of the plurality of rolling bodies has a fixed axis of rotation about which each of the rolling bodies rotates, each of the rolling bodies being rotatably attached to the roller bearing such that the fixed axis of rotation about which each of the rolling bodies rotates remains substantially parallel to the central axis of the roller bearing.

### DESCRIPTION OF THE FIGURES

For the present invention to be understood clearly and readily practiced, the present invention will be described in conjunction with the following figures, wherein:

FIG. 1 is a schematic plane view of a bearing according to an embodiment of the present invention;

FIG. 2 is a sectional view along sectional line A-A according to the embodiment illustrated in FIG. 1;

FIG. 3 is a cross-sectional view of the bearing illustrated in FIG. 1;

FIG. 4 is an exploded view of a bearing of the bearing illustrated in FIG. 1;

FIG. 5 is a three-dimensional perspective view of the bearing illustrated in FIG. 1;

FIGS. 6 through 9 illustrate an exemplary method for assembling a bearing according to an embodiment of the present invention;

FIG. 10 is a schematic plane view of a bearing according to an embodiment of the present invention;

FIG. 11 is a sectional view along sectional line B-B of the bearing illustrated in FIG. 10;

FIG. 12 is a three-dimensional cut view along sectional line B-B of the bearing illustrated in FIG. 10;

FIG. 13 is a schematic plane view of a bearing according to an embodiment of the present invention;

FIG. 14 is a cross-sectional view along section line C-C of the bearing illustrated in FIG. 13.

FIG. 15 is a schematic plane view of a bearing according to an embodiment of the present invention;

FIG. 16 illustrates a variety of exemplary roller shapes suitable for practicing the present invention;

FIG. 17 is a cross sectional view of a bearing according to an embodiment of the present invention;

FIG. 18 is an exploded view of the bearing illustrated in FIG. 17;

FIG. 19 is a three-dimensional cut view of the bearing illustrated in FIG. 17;

FIG. 20 is a cross sectional view of a bearing according to another embodiment of the present invention;

FIG. 21 is an exploded view of the bearing illustrated in FIG. 20;

FIG. 22 is a three-dimensional cut view of the bearing illustrated in FIG. 20.

### DETAILED DESCRIPTION OF THE INVENTION

The present invention relates to a bearing having a plurality of rolling bodies disposed between an inner ring (or race) and an outer ring (or race). Each of the rolling bodies has an axis of rotation, and the races have a central axis of rotation. The bearing of the present invention resists binding between the rolling bodies and the races by maintaining the axes of rotation of the rolling bodies parallel to the central axis of the inner and outer races and by remaining free to roll on the race track. Traditional bearing cages, when subject to certain loads, impinge the rolling bodies, causing the bearing to have increased friction and to possibly jam The bearing of the present invention resists this sliding and/or jamming not only when subject to radial, axial, or centrifugal loads (or combinations thereof) but also forces generated at an axis of rotation external to the bearing.

For a general understanding of the features of the present invention, reference is made to the drawings, wherein like reference numerals have been used throughout to identify similar elements. Where reference numerals identify a collection of like elements, a lower case letter designation used in combination with the reference number identifies individual elements of the collection. The lower case letter designations are assigned to elements alphabetically in a counterclockwise fashion and, in the case of a collection of elements arranged linearly, the alphabetical designations proceed from top to bottom.

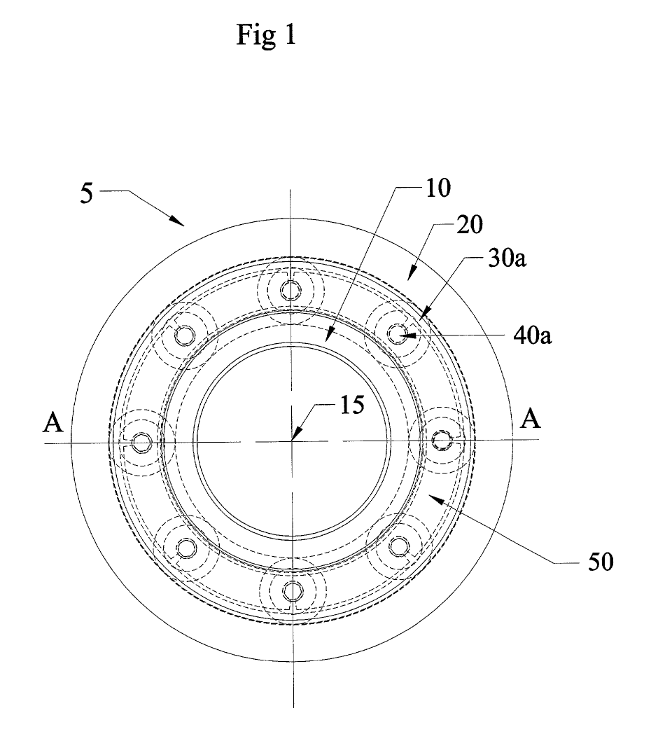

FIG. 1 is a schematic plane view of a bearing 5 according to an embodiment of the present invention. As shown in FIG. 1, bearing 5 includes an inner race 10, an outer race 20, a plurality of bored rollers commonly designated as 30, a plurality of pins commonly designated as 40, and two retaining disks 50 (one shown). The components of bearing 5 may be made from any sufficiently hard and durable material, such as steel. Inner race 10 is arranged substantially concentric and coplanar with outer race 20. Inner race 10 and outer race 20 have a common central axis 15. Bored rollers 30 may be disposed in a space between races 10 and 20 at substantially equal intervals, as shown in FIG. 1, and are configured to roll against races 10 and 20. So arranged, bored rollers 30 have centers at a common radius measured from central axis 15 of concentric races 10 and 20. According to an embodiment, pins 40 may be inserted through bored rollers 30 so that rollers 30 may rotate independently of pins 40. Retaining disks 50 may then be used to secure pins 40 from moving in the longitudinal direction while allowing pins 40 to rotate independently of retaining disk 50.

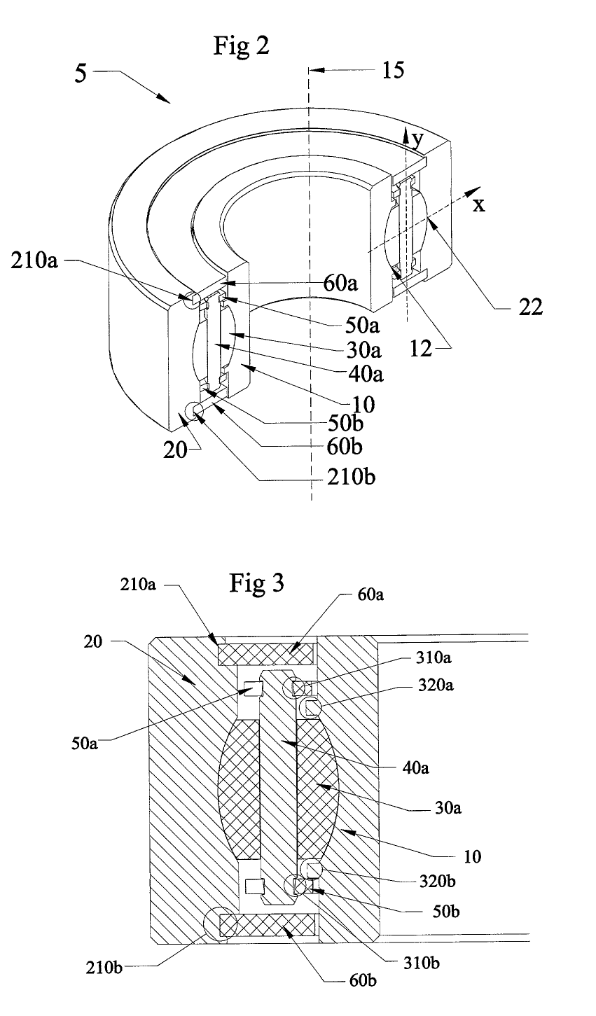

FIG. 2 is a sectional view of bearing 5 along sectional line A-A. As shown in FIG. 2, bearing 5 includes roller 30a disposed between races 10 and 20, pin 40a, a top retaining disk 50a and a bottom retaining disk 50b (collectively, “retaining disks 50”), a top shield 60a and a bottom shield 60b (collectively, “shields 60”), and a top groove 210a and a bottom groove 210b (collectively, “grooves 210”). The inwardly facing surface of outer race 20 is provided with a race track 22 while the outwardly facing surface of inner race 10 is also provided with a race track 12.

As described in connection with FIG. 1, retaining disks 50 restrict longitudinal movement of pins 40 in a manner that permits rollers 30 to rotate independent of retaining disks 50. According to the embodiment illustrated in FIG. 2, retaining disks 50 secure pins 40 by a snap fit. Those of ordinary skill in the art will appreciate, however, that other permanent or releasable fastening mechanisms may be used.

Shields 60 may be positioned between inner and outer races 10 and 20 and axially outside race tracks 12 and 22 to maintain lubricants and exclude foreign material with respect to the gearing. Shields 60 may be disposed at both axial ends of race tracks 12 and 22, and do not interfere with the rotation of the inner race. In the embodiment shown, shields 60 are fixedly attached in annular grooves 210 provided in outer race 20. According to an embodiment, each shield 60 may have a flexible inner edge that is adapted to slidingly contact inner race 10 along an arcuate recess provided along the outer periphery of inner race 10 at the axial ends. According to another embodiment, shields 60 may be fixedly attached in annular grooves provided in inner race 10.

FIG. 3 is a cross-sectional view of bearing 5. Bearing 5 includes roller 30a disposed between races 10 and 20, pin 40a, top and bottom retaining disks 50a and 50b, top and bottom shields 60a and 60b, a top notch 310a and a bottom notch 310b (collectively, “notches 310”) in pin 40a, a top rim 320a, and a bottom rim 320b (collectively, “rims 320”) on inner race 10. Notches 310, in combination with pin 40a, are adapted to receive retaining disks 50 using, for example, a conventional snap-fit fastening technique. According to such an embodiment, notches 310 are adapted to allow pins 40 to rotate independent of retaining disks 50.

Rims 320 of bearing 5 provide retaining means to prevent pins 40 and retaining disks 50 from moving axially and interfering with the operation of rollers 30. More specifically, inner race 10 includes top and bottom rims 320a and 320b so that if, for example, retaining disk 50b were to move upward in the axial direction, disk 50a would be limited by rim 320b. According to another embodiment, rims may additionally or alternatively extend from outer race 20.

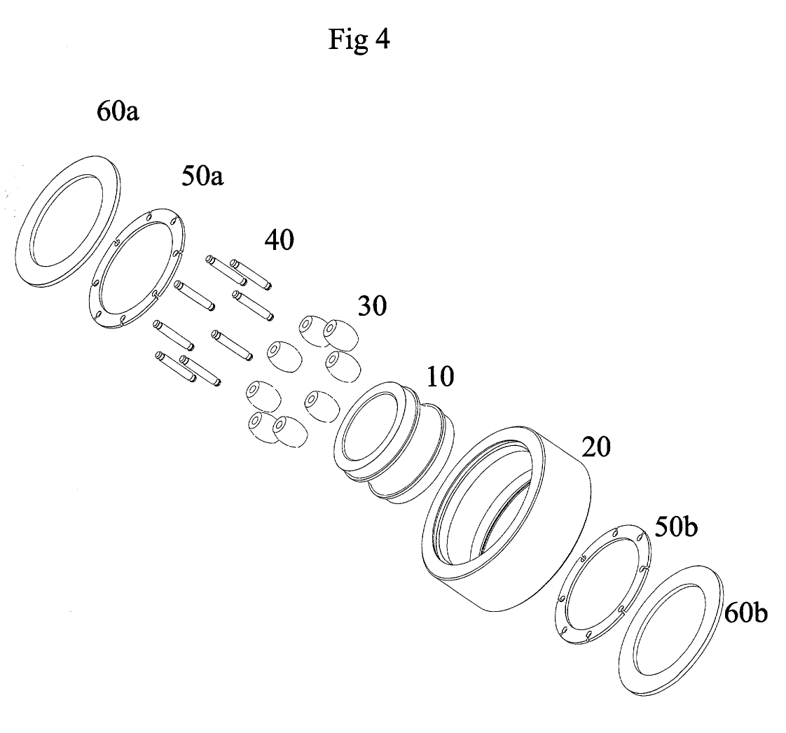

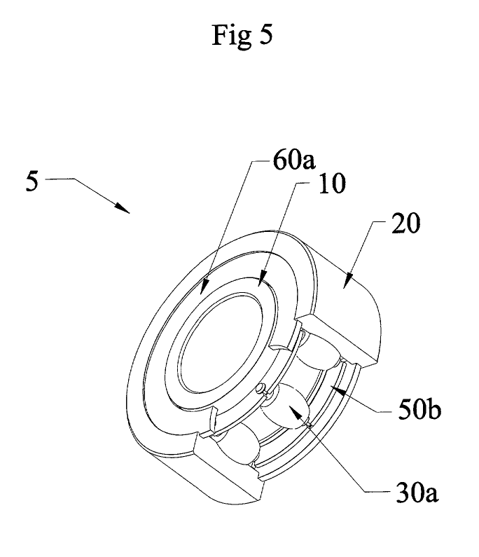

FIGS. 4 and 5 illustrate various views of bearing 5. FIG. 4 is an exploded view of a bearing 5. FIG. 4 illustrates the components of bearing 5 including inner race 10, outer race 20, bored rollers 30, pins 40, retaining disks 50, and shields 60. Once assembled, retaining disks 50 and shields 60 engage inner and outer races 10 and 20. FIG. 5 is a three-dimensional view of bearing 5 with a section cut out to illustrate the inner assembly. To prevent binding of rollers 30, races 10 and 20 should be fabricated to allow, for example, 0.001 inch between rollers 30 and races 10 and 20.

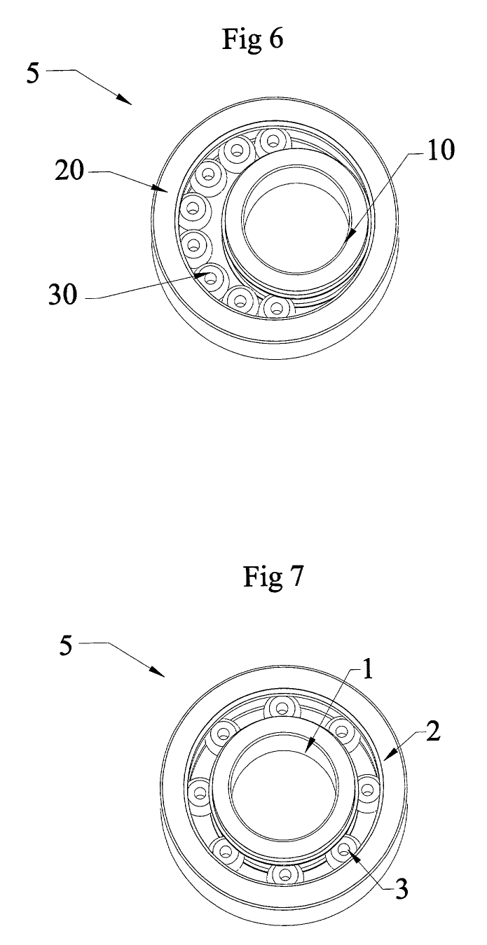

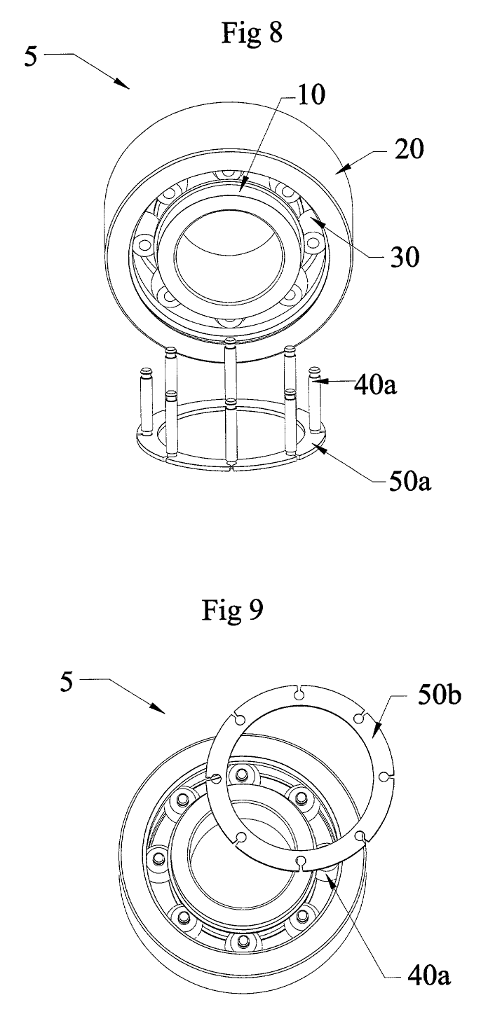

FIGS. 6 through 9 illustrate an exemplary method for assembling a bearing according to an embodiment of the present invention. First, rollers 30 may be rotated to fill approximately one half of inner race 10 as illustrated in FIG. 7 Second, rollers 30 may then be moved around inner race 10, as illustrated in FIG. 7, into approximately evenly spaced locations. Third, as shown in FIG. 8 retaining disk 50b, with pins 40 attached, may be inserted into bearing 5 so that pins 40 slip through the bored shafts of rollers 30. Finally, in the fourth step, retaining disk 50a is attached to the opposite end of pins 40 as shown in FIG. 9. Shields 60 may optionally be placed over retaining disks 50.

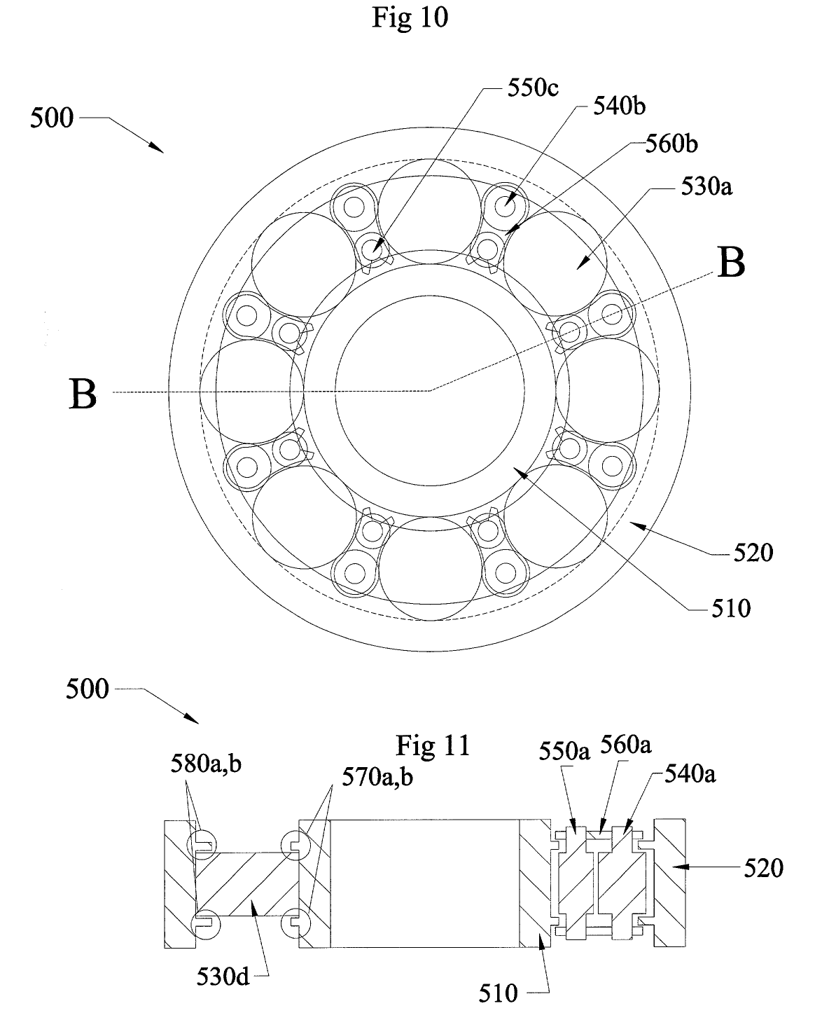

FIG. 10 is a schematic plane view of a bearing 500 according to an embodiment of the present invention. Bearing 500 includes an inner race 510, an outer race 520, a plurality of rollers commonly designated as 530, a plurality of outer spacer rollers commonly designated 540, a plurality of inner spacer rollers commonly designated 550, and a plurality of retaining clips commonly designated 560. According to such an embodiment, rollers 530 are disposed between inner race 510 and outer race 520 and spaced approximately equal distances apart. Outer spacer roller 540a is positioned tangentially to adjacent rollers 530a and 530b but does not touch outer race 520. Inner space roller 550a is also positioned tangentially to adjacent rollers 530a and 530b but closer to inner race 510 without touching it. Retaining clip 560a is not fixedly attached to spacer rollers 540a and 550a, but instead allows spacer rollers 540a and 550a to rotate about their respective axes.

When inner race 510 rotates, such as by contact with a shaft, rollers 530 begin to roll against outer race 520. Spacer rollers 540 and 550 further limit radial movement of rollers 530 as they rotate around inner race 510. Additionally, where spacer rollers 540 and 550 contact rollers 530, the rotation of rollers 530 causes spacer rollers 540 and 550 also to rotate.

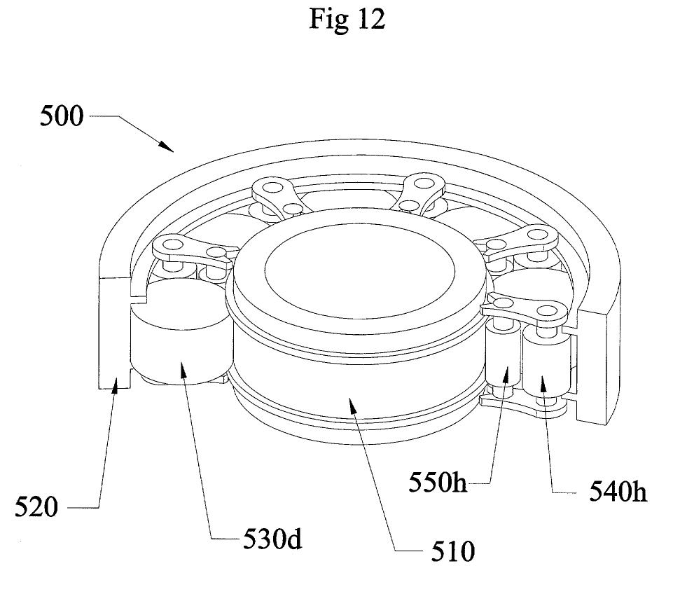

FIG. 11 is a sectional view of bearing 500 along sectional line B-B. As shown, bearing 500 includes inner and outer races 510 and 520, roller 530d, outer spacer roller 540a, inner spacer roller 550a, retaining clip 560a, a top inner rim 570a, a bottom inner rim 570b, a top outer rim 580a, and a bottom outer rim 580b. Inner race 510 includes top and bottom inner rims 570 that limit axial movement of rollers 530 and retaining clips 560. FIG. 12 is a three-dimensional cut view of bearing 500 along sectional line B-B of FIG. 10.

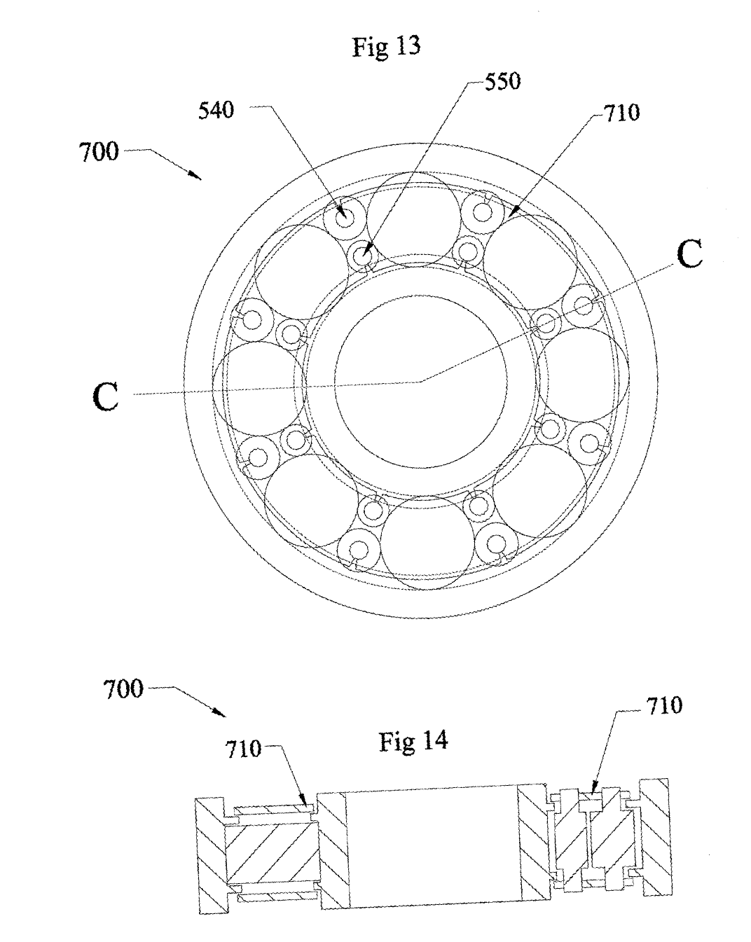

FIG. 13 is a schematic plane view of a bearing 700 according to an embodiment of the present invention. This embodiment is similar to that shown in FIGS. 10 through 12 except that retaining clips 560 have been combined to form a retaining disk 710 that holds spacer rollers 540 and 550. FIG. 14 is a cross-sectional view of bearing 700 along section line C-C of FIG. 13 that illustrates retaining disk 710.

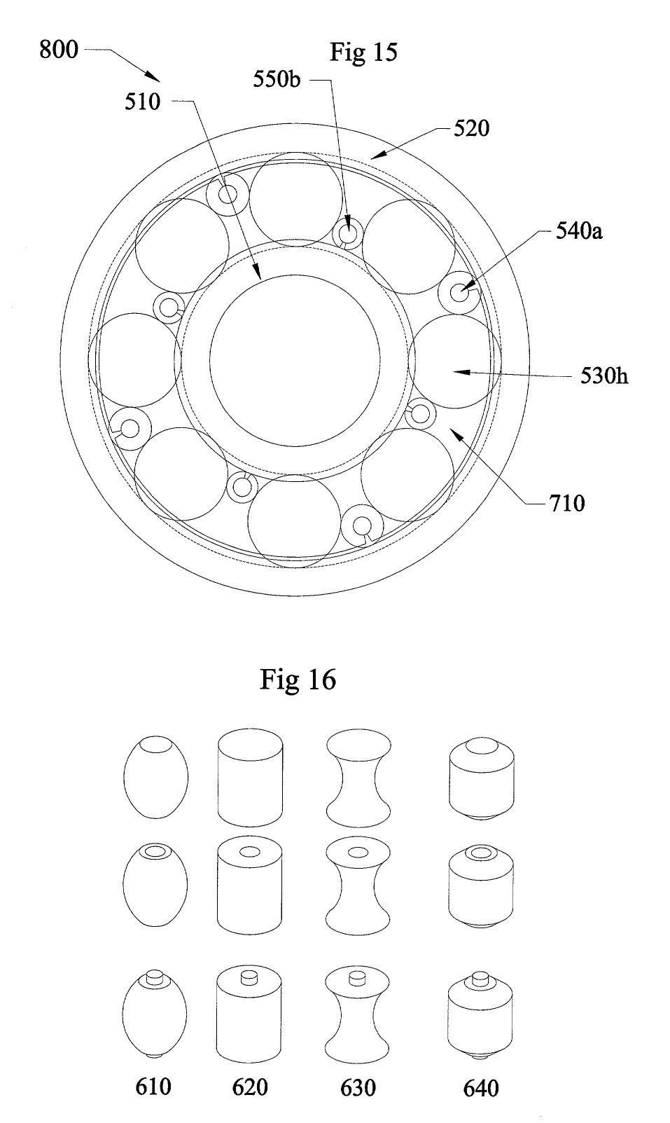

FIG. 15 is a schematic plane view of a bearing 800 according to an embodiment of the present invention. This embodiment is similar to that shown in FIGS. 13 and 14 except that every other inner spacer roller 550 and every other outer spacer roller 540 is removed. Retaining disk 710 holds spacer rollers 540 and 550 apart and within inner race 10 and outer race 20.

FIG. 16 illustrates a variety of exemplary roller shapes suitable for practicing the present invention, including elliptical, cylindrical, spindle, and barrel shapes. Those of ordinary skill in the art will appreciate, however, that any complementary shape symmetric with respect to an axis of rotation may be suitable. The barrel design is preferred because it is self-centering, i.e., its axis of rotation stops parallel to the axes of the inner and outer races, forcing the components to maintain a state of levelness during operation. Those of ordinary skill in the art will also appreciate that the rollers may be solid as illustrated in FIGS. 11 through 14 or, preferably, bored as illustrated in FIG. 1. According to another embodiment, the pins and roller can be combined into a unitary structure as illustrated in FIGS. 11 through 14, although the pins and rollers cannot rotate independently.

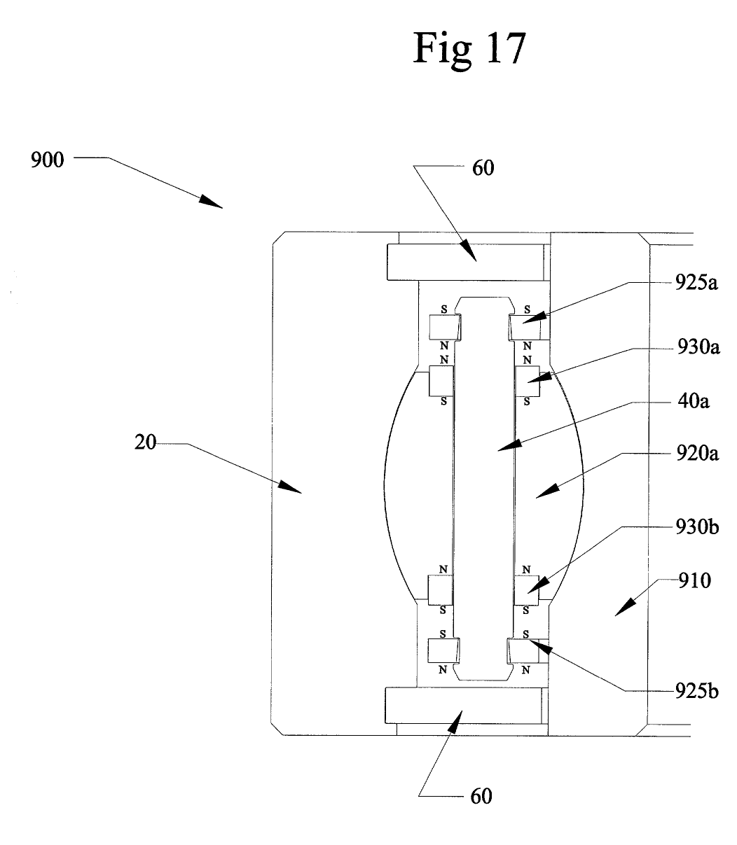

FIG. 17 is a cross sectional view of a bearing 900 according to an embodiment of the present invention. Bearing 900 includes an inner race 910, an outer race 20, a roller 920a, pin 40a, top and bottom shields 60, a top magnetic disk 920a, a bottom magnetic disk 920b (collectively, “magnetic disks 920”), and a top circular magnetic washer 930a and a bottom circular magnetic washer 930b (collectively, “magnetic washers 930”) on roller 920a. Bearing 900 is similar to bearing 500 shown in FIG. 1 except that retaining disks 50 and rims 320 of bearing 500 have been replaced by a plurality of magnetic disks and washers. The polarities of magnetic disks 920 and magnetic washers 930 are arranged to repel each other to further limit axial displacement of pins 40 during operation of bearing 900.

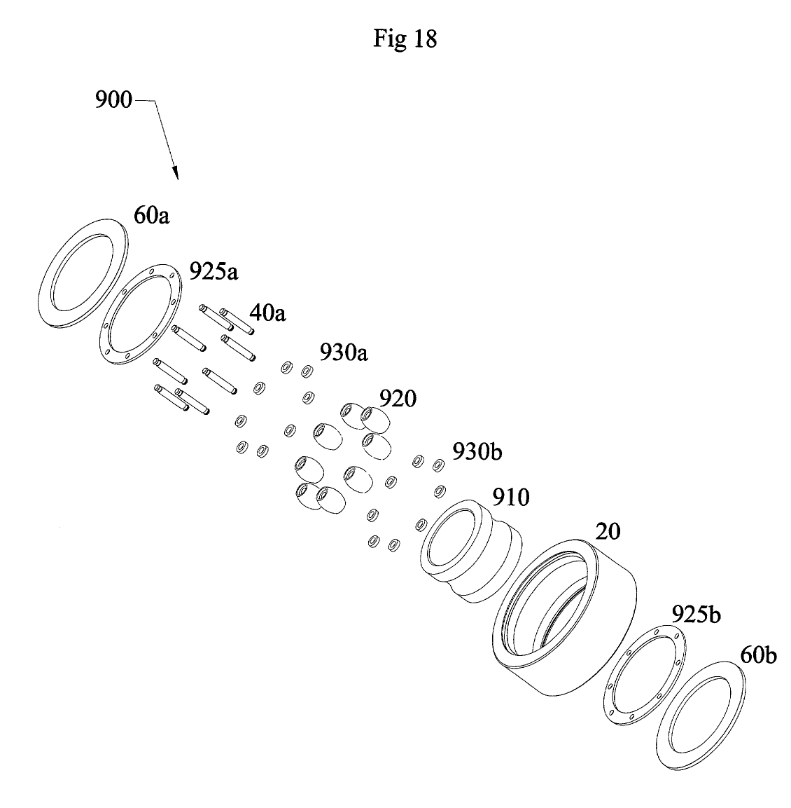

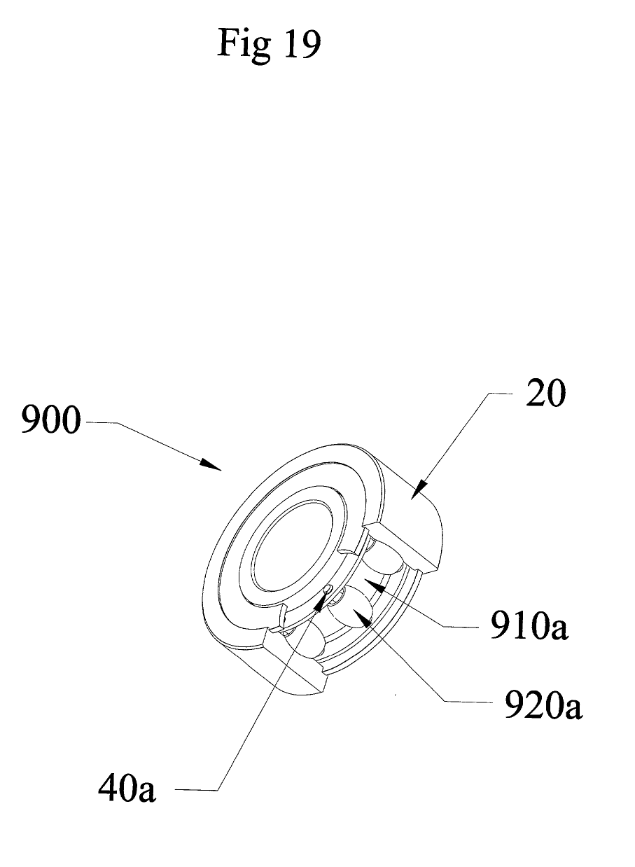

FIG. 18 is an exploded view of bearing 900 that shows, like FIG. 17, magnetic washers 930 inserted into roller 920a. Those of ordinary skill in the art will appreciate, however, that magnetic washers 930 may be attached to the top, partially sunk into the end of rollers 920 or completely sunk so that a surface of magnetic washers 930 are flush with a top surface of rollers 920. FIG. 19 is a three-dimensional cut view of bearing 900.

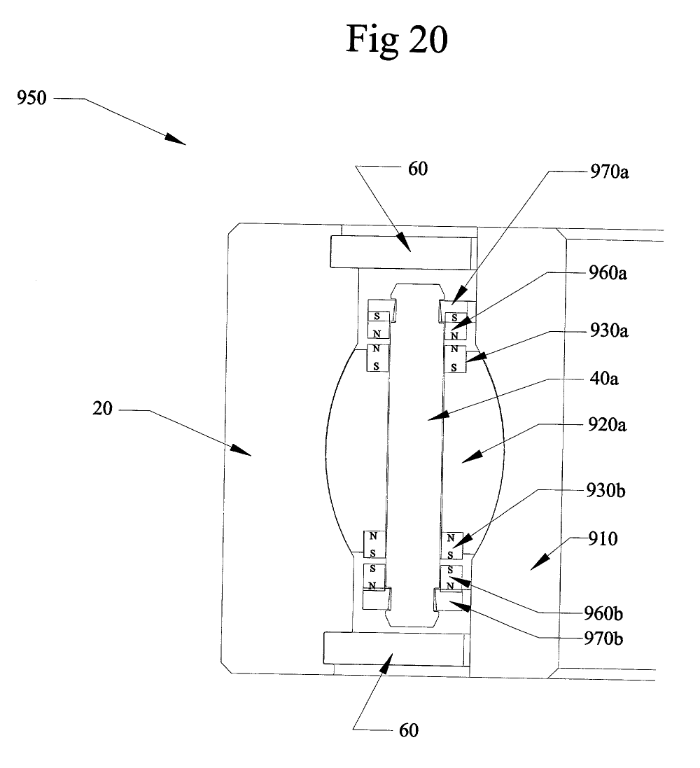

FIG. 20 is a cross sectional view of a bearing 950 according to another embodiment of the present invention. Bearing 950 includes inner race 910, outer race 20, roller 920a, pin 40a, shields 60, a top magnetic washer 960a mounted to a top retaining disk 970a, and a bottom magnetic washer 960b mounted to a bottom retaining disk 970b. Bearing 950 is similar to bearing 900 except that retaining disks 970 have magnetic washers 960 mounted into them, rather than full magnetic disk of bearing 900. Washers 960 may be partially sunk into retaining disks 970 or completely sunk such that the surface of, for example, magnetic washer 960a is flush with the roller-side surface of retaining disk 970a.

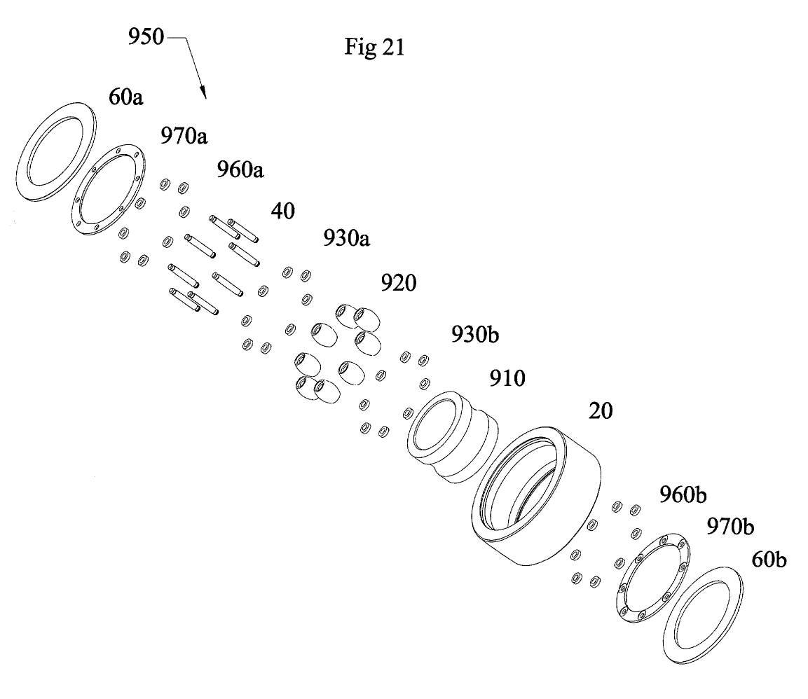

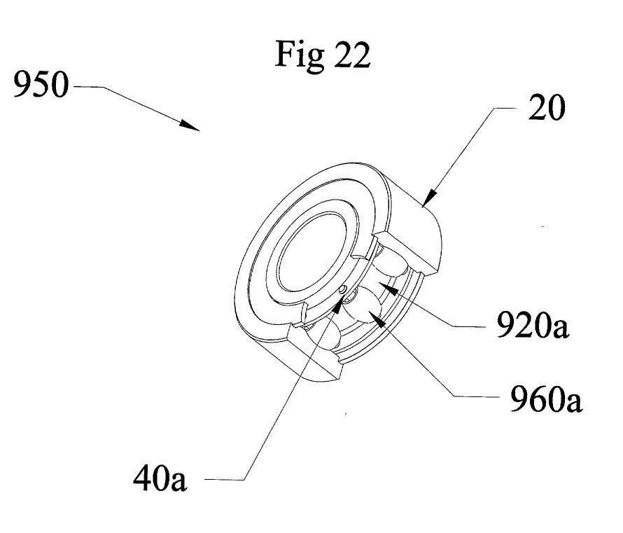

FIG. 21 is an exploded view of bearing 950 that illustrates the manner in which magnetic washers 930 may be inserted into roller 920a. FIG. 21 also illustrates the manner in which magnetic washers 960 may be mounted on retaining disks 970. FIG. 22 is a three-dimensional cut view of bearing 900.

It can thus be appreciated that while the invention has been particularly shown and described with respect to preferred embodiments thereof, it will be understood by those skilled in the art that changes in form and details may be made therein without departing from the scope and spirit of the invention.

What is claimed is:

1. A roller bearing having a central axis comprising:
an inner race having a first race track;
an outer race disposed concentrically around the inner race with respect to the central axis and having a second race track facing the first race track; and
a plurality of rolling bodies disposed between the inner race and the outer race for rolling against the first race track and the second race track;
wherein each of the plurality of rolling bodies has a fixed axis of rotation about which each of the rolling bodies rotates, each of the rolling bodies being rotatably attached to the roller bearing such that the fixed axis of rotation about which each of the rolling bodies rotates remains substantially parallel to the central axis of the roller bearing.

2. The roller bearing according to claim 1 wherein the rolling bodies have a shape that is elliptical, cylindrical, spindle, or barrel-like.

3. The roller bearing according to claim 1 wherein at least one of the plurality of rolling bodies includes a pin disposed along the axis of rotation of the rolling body.

4. The roller bearing according to claim 3 wherein the at least one of the plurality of rolling bodies and the pin form a unitary structure.

5. The roller bearing according to claim 3 wherein the pin is capable of rotating independently of the at least one of the plurality of rolling bodies.

6. The roller bearing according to claim 1 further comprising
a retaining disk;
wherein at least one of the rolling bodies is rotatably attached to the retaining disk.

7. The roller bearing according to claim 6 wherein the rotatable attachment is by a snap fit.

8. The roller bearing according to claim 6 further comprising a rim fixedly attached to the inner race and disposed between the retaining disk and the plurality of rolling bodies.

9. The roller bearing according to claim 6 further comprising a rim fixedly attached to the outer race and disposed between the retaining disk and the plurality of rolling bodies.

10. The roller bearing according to claim 6 further comprising a seal disposed over the retaining disk and attached to the roller bearing by a tongue and groove mechanism.

11. The roller bearing according to claim 1 further comprising
a plurality of inner spacer rollers adapted to engage at least one of the plurality of rolling bodies;
a plurality of outer spacer rollers adapted to engage the at least one of the plurality of rolling bodies; and
a plurality of retaining clips rotatably attached to the plurality of inner spacer rollers and the plurality of outer spacer rollers.

12. The roller bearing according to claim 11 further comprising
a retaining disk;
wherein at least one of the inner spacer rollers and at least one of the outer spacer rollers are rotatably attached to the retaining disk.

13. The roller bearing according to claim 1 further comprising
a first magnet fixedly attached to at least one of the plurality of rolling bodies and disposed along its axis of rotation; and
a second magnet attached to the roller bearing, the second magnet being positioned along the axis of rotation of the at least one of the plurality of rolling bodies;
wherein the first magnet repels the second magnet.

14. The roller bearing according to claim 6 further comprising a magnet fixedly attached to at least one of the plurality of rolling bodies and disposed along its axis of rotation, wherein the retaining disk is magnetic such that the retaining disk repels the magnet.

15. A roller bearing, comprising:
an inner race having a first race track;
an outer race disposed concentrically around the inner race and having a second race track facing the first race track;
a retaining disk disposed between the inner race and the outer race; and
a plurality of rolling bodies each having an axis of rotation, the plurality of rolling bodies being disposed between the inner race and the outer race for rolling against the first race track and the second race track, and the plurality of rolling bodies being rotatably attached to the retaining disk to rotate around their respective axes of rotation.

16. The roller bearing according to claim 15 wherein the rolling bodies have a shape that is elliptical, cylindrical, spindle, or barrel-like.

17. The roller bearing according to claim 15 wherein at least one of the plurality of rolling bodies includes a pin disposed along the axis of rotation of the rolling body.

18. The roller bearing according to claim 17 wherein the at least one of the plurality of rolling bodies and the pin form a unitary structure.

19. The roller bearing according to claim 17 wherein the pin is capable of rotating independently of the at least one of the plurality of rolling bodies.

20. The roller bearing according to claim 15 further comprising
a plurality of inner spacer rollers adapted to engage at least one of the plurality of rolling bodies;
a plurality of outer spacer rollers adapted to engage the at least one of the plurality of rolling bodies; and
a plurality of retaining clips rotatably attached to the plurality of inner spacer rollers and the plurality of outer spacer rollers.

21. The roller bearing according to claim 20 further comprising
a retaining disk;
wherein at least one of the inner spacer rollers and at least one of the outer spacer rollers are rotatably attached to the retaining disk.

22. The roller bearing according to claim 15 further comprising
a first magnet fixedly attached to at least one of the plurality of rolling bodies and disposed along its axis of rotation; and
a second magnet attached to the roller bearing, the second magnet being positioned along the axis of rotation of the at least one of the plurality of rolling bodies;
wherein the first magnet repels the second magnet.

23. The roller bearing according to claim 21 further comprising a magnet fixedly attached to at least one of the plurality of rolling bodies and disposed along its axis of rotation, wherein the retaining disk is magnetic such that the retaining disk repels the magnet.

24. A method for assembling a bearing comprising:
providing an inner race having a track and an outer race having a track;
arranging the inner race relative to the outer race such that the race track of the outer race faces the race track of the inner race;
inserting a plurality of bored rolling bodies between the inner race and the outer race for rolling against the race tracks;
moving the plurality of bored rolling bodies around the inner race and the outer race to approximately evenly spaced locations;
inserting pins having top and bottom ends through at least two of the plurality of bored rolling bodies; and
placing retaining disks over the top and bottom ends of the pins.

25. The method according to claim 24 further comprising
positioning a shield over at least one of the retaining disks.

26. The method according to claim 24 further comprising
positioning the plurality of rolling bodies to fill approximately half of the inner race.

27. A roller bearing having a central axis comprising:
an inner race having a first race track;
an outer race disposed concentrically around the inner race with respect to the central axis and having a second race track facing the first race track;
a plurality of rolling bodies disposed between the inner race and the outer race for rolling against the first race track and the second race track;
wherein each of the plurality of rolling bodies has an axis of rotation, and the rolling bodies are rotatably attached to the roller bearing such that the axis of rotation of each of the rolling bodies remains substantially parallel to the central axis of the roller bearing; and
retaining means to minimize displacement of the plurality of rolling bodies.

28. The roller bearing according to claim 27 wherein the retaining means minimizes axial displacement of the plurality of rolling bodies.

29. The roller bearing according to claim 27 wherein the retaining means minimizes displacement of the axes of the plurality of rolling bodies with respect to the central axis.
